(19) United States
(12) Patent Application Publication
(10) Pub. No.: US 2006/0291013 A1
(43) Pub. Date: Dec. 28, 2006

(54) Image reading apparatus, image reading method, and program for executing the image reading method

(75) Inventor: Koji Shimizu, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Tokyo (JP)

(21) Appl. No.: 11/473,093

(22) Filed: Jun. 22, 2006

(30) Foreign Application Priority Data
Jun. 28, 2005 (JP) 2005-188299
Dec. 20, 2005 (JP) 2005-366452

(51) Int. Cl. H04N 1/04

(52) U.S. Cl. 358/498

(57) ABSTRACT

An image reading apparatus that is capable of reading a two-sided document is configured to prevent an increase in a size of an image processing circuit and also an increase in a capacity of a memory for temporarily storing data, in reading the two-sided document by using two reading units, and also to simplify the handling of data. To accomplish this, the image reading apparatus is provided with two reading units and carries out a reading operation of the two-sided document at two mutually different positions, which are distant from each other by a distance equivalent to a length of the document.

### BACKGROUND OF THE INVENTION

1. Field of the Invention

The present invention relates to an image reading apparatus and method for reading an image of a document fed from a document feeding apparatus, and also relates to a program for executing the image reading method.

2. Description of the Related Art

Conventionally, document feeding apparatuses have been made available that can be operated both in a document fixed-reading mode in which a document is fed and placed onto a document glass stand and an image of the document is read by moving a reading optical system and in a document feeding-reading mode in which an image is read while feeding a document by fixing a reading optical system.

For example, Japanese Patent Application Laid-Open No. 07-110641 discloses a technology for a document feeding apparatus that can be operated both in the document fixed-reading mode and the document feeding-reading mode and also is capable of performing control such as switching between the document fixed-reading mode and the document feeding-reading mode by using various kinds of setting modes that a user desires.

In addition, in recent years, Japanese Patent Application Laid-Open No. 2001-251474, for example, discloses an automatic document feeding apparatus (auto document feeder) capable of reading both sides of the document at the same time by disposing a reading optical system on each side of a document reading conveyance path. In such an apparatus, a two-sided document is read at the same time while the document is fed by fixing the reading optical system at each of a front side reading position and a back side reading position. Thus, productivity of a two-sided document reading apparatus can be improved and a time for exchanging the document can be shortened.

An image reading apparatus which is used in simultaneously carrying out image processing of image data of the front side and the back side of a document read at the same time by the above-mentioned conventional technology is shown in FIG. 18, which includes an image sensor control unit 1000. In particular, an image reading apparatus CPU circuit unit 1000 is provided that controls over the image reading apparatus is provided with a CPU 1001, a ROM 1002, and a RAM 1003. The ROM 1002 stores a program. The RAM 1003 is used as an area in which control data is temporarily stored and a work area for computation performed during a control operation.

The image reading apparatus CPU circuit unit 1000 controls a front side reading unit control unit 1006 and a front side reading unit 1004 to read image data of the front side of a document. In addition, the image reading apparatus CPU circuit unit 1000 controls a back side reading unit control unit 1007 and a back side reading unit 1005 to read image data of the back side of a document.

The image data of the front side and the image data of the back side that are read at the same time are sent to an image processing unit for front side 1008 and an image processing unit for back side 1009, respectively, and are subjected to processing such as a shading correction. Each of an image memory unit for front side 1010 and an image memory unit for back side 1011 is a memory for writing and reading image information.

However, with this configuration, costs for manufacturing the apparatus increase because an image processing unit and an image memory unit need to be provided for both the front side and the back side. In addition, in a case where the image processing unit for front side 1008 and the image processing unit for back side 1009 are implemented by providing one single image processing unit, the size of the image processing unit increases. Further, in this case, it is necessary to improve a processing capacity of the image processing unit, and, therefore, the costs for manufacturing the apparatus increase.

Moreover, in a case where an image processing unit is provided only for one side of a document, there is an example shown in a block diagram in FIG. 19A that illustrates an image sensor control unit 2000 of the image reading apparatus. In particular, an image reading apparatus CPU circuit unit 2000 is provided with a CPU 2001, a ROM 2002, and a RAM 2003. The ROM 2002 stores a program. The RAM 2003 is used as an area in which control data is temporarily stored and a work area for computation performed during a control operation. The image reading apparatus CPU circuit unit 2000 controls a front side reading unit control unit 2006 and a front side reading unit 2004 to read image data of the front side of a document.

In addition, the image reading apparatus CPU circuit unit 2000 controls a back side reading unit control unit 2007 and a back side reading unit 2005 to read image data of the back side of a document. The image data is sent to an image processing unit 2008 and is subjected to processing such as a shading correction. The image processing unit 2008 carries out image processing for image data of each of the front and the back sides in an appropriate order.

An image memory unit 2009 is a memory for writing and reading the image information. In the case of this configuration, it is not possible to simultaneously perform processing on the image data of the front and the back sides read at the same time. Accordingly, the apparatus is provided with a memory for storing image data 2010 that stores image data read into the image reading apparatus CPU circuit unit 2000 and temporarily stores the read image data.

FIG. 19B shows an example of timing of storage of image data. Reading operations (1) and (2) of image data of the front and the back sides of a first document are carried out about at the same time. Then, first, the image processing unit 2008 performs image processing (1)′ for the front side of the first document. In the meantime, the reading of the back side of the first document is being carried out, and the read image data of the back side of the first document is temporarily stored in the memory for storing image data 2010 ((2)″). When the image processing (1)′ for the front side of the first document ends, the CPU 2001 immediately sends the image data of the back side of the first document to the image processing unit 2008 to perform image processing (2)′ of the back side of the first document. With respect to reading of a second document, the second document is fed to the reading unit at the timing at which the image processing (2)′ of the back side of the first document ends. Reading operations (3) and (4) of image data of the front and the back sides of the second document are carried out about at the same time. Then, the image processing unit 2008 performs image processing (3)′ for the front side of the second document. In the meantime, the reading of the back side of the second document is being carried out, and the read image data of the back side of the second document is temporarily stored in the memory for storing image data 2010 ((4)″). When the image processing (3)′ for the front side of the second document ends, the CPU 2001 immediately sends the image data of the back side of the second document to the image processing unit 2008 to perform image processing (4)′ of the back side of the second document. For a third and subsequent documents, the above operation is repeated to perform the image processing in an appropriate order.

As described above, it is necessary to at least temporarily store either of the image data (for example, the image data of the back side in this case) of the front side and the image data of the back side that are simultaneously read into the memory for storing image data 2010 and the like until the image processing for at least one side ends.

As a result of the configurations of the aforementioned imaging systems, the costs for manufacturing increase and handling of data becomes too complicated. Therefore, it would be beneficial to provide an imaging apparatus and system, which overcomes these disadvantages.

### SUMMARY OF THE INVENTION

According to a first exemplary embodiment of the present invention, an image reading apparatus including an automatic document feeding unit adapted to feed a document that is stacked onto a document stacking stand to a reading position and being capable of reading both images of a front side and a back side of the document includes a size information obtaining unit adapted to obtain size information of the document, a first reading unit adapted to read an image of one side of the document, a second reading unit adapted to read an image of another side of the document, and a moving unit adapted to move the second reading unit, wherein the first reading unit reads the image of one side of the document at a first reading position, wherein the moving unit moves the second reading unit to a second reading position that is different from the first reading position, in accordance with the size information of the document obtained by the size information obtaining unit, and wherein the second reading unit reads the image of another side of the document at the second reading position.

Moreover, according to another exemplary embodiment of the present invention, an image reading method for an image reading apparatus including an automatic document feeding unit adapted to feed a document that is stacked onto a document stacking stand to a reading position and being capable of reading both images of a front side and a back side of the document includes a size information obtaining step of obtaining size information of the document, a first reading step of reading an image of one side of the document by a first reading unit, a second reading step of reading an image of another side of the document by a second reading unit, and a movement controlling step of moving the second reading unit, wherein in the first reading step, the first reading unit reads the image of one side of the document at a first reading position, wherein in the movement controlling step, the second reading unit is moved to a second reading position that is different from the first reading position, in accordance with the size information of the document obtained in the size information obtaining step, and wherein in the second reading step, the second reading unit reads the image of another side of the document at the second reading position.

According to aspects of several of the aforementioned embodiments of the present invention, image data of one side and image data of another side of the document can be serially processed in an appropriate order. Accordingly, a size of an image processing circuit can be made small, and further, reading of two sides of a document can be implemented at low manufacturing cost and also with a simple configuration.

Additionally, according to aspects of some of the aforementioned embodiments of the present invention, in serially performing image processing after performing reading of two sides of a document, it is not necessary to provide an image memory for temporarily storing image data.

That is, even if an image memory for buffering is provided, a capacity of the memory is sufficient with a capacity smaller than the capacity necessary for storing image data of one page of a document. In addition, complicated handling of data is unnecessary, and, therefore, a good productivity for two-sided documents can be secured.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous embodiments of the present invention and, together with the description, serve to explain the principles of the invention.

FIG. 1 is a schematic diagram showing an exemplary configuration of an image forming apparatus according to a first embodiment of the present invention.

FIG. 2 is a schematic diagram showing an exemplary configuration of a document feeding apparatus according to the first embodiment of the present invention.

FIG. 3 is a block diagram showing an exemplary configuration of a control unit of the image forming apparatus according to the first embodiment of the present invention.

FIG. 4 is a block diagram showing an exemplary configuration of an image reader control unit according to the first embodiment of the present invention.

FIG. 5 is a block diagram showing an exemplary configuration of an image signal control unit according to the first embodiment of the present invention.

FIG. 6 is a block diagram showing an exemplary configuration of a document feeding apparatus control unit according to the first embodiment of the present invention.

FIG. 7 is a schematic diagram showing an external appearance of an exemplary operation unit of the image forming apparatus according to the first embodiment of the present invention.

FIG. 8 is a schematic diagram showing an exemplary basic screen displayed on an LCD display section of the operation unit of the image forming apparatus according to the first embodiment of the present invention.

FIG. 9A is a flow chart showing a flow of an exemplary document reading mode setting according to the first embodiment of the present invention.

FIG. 9B is a diagram showing various types of operation modes of the document feeding apparatus.

FIG. 10 is a flow chart showing an exemplary separation operation according to the first embodiment of the present invention.

FIG. 11 is a flow chart showing an exemplary reading operation according to the first embodiment of the present invention.

FIG. 12 is a schematic diagram showing reading positions in reading a two-sided document according to the first embodiment and a second embodiment of the present invention.

FIG. 13 is a diagram showing exemplary timing of processing of image data carried out by the image reader control unit according to the first embodiment of the present invention.

FIG. 14 is a diagram showing exemplary timing of processing of image data carried out by the image reader control unit according to the second embodiment of the present invention.

FIG. 15 is a schematic diagram showing reading positions in reading a two-sided document according to a third embodiment of the present invention.

FIG. 16 is a diagram showing exemplary timing of processing of image data carried out by the image reader control unit according to the third embodiment of the present invention.

FIG. 17 is a schematic diagram showing an exemplary reading setting screen for a pull scan function as displayed by an external computer according to a fourth embodiment of the present invention.

FIG. 18 is a block diagram showing an image sensor control unit of an image reading apparatus using a conventional technology.

FIG. 19A is a block diagram showing an image sensor control unit of an image reading apparatus using a conventional technology.

FIG. 19B is a schematic diagram showing timing of processing of image data carried out by an image reader control unit of the image reading apparatus shown in FIG. 19A.

### DETAILED DESCRIPTION OF THE EMBODIMENTS

Numerous exemplary embodiments, features and aspects of the present invention will now be described in detail with reference to the drawings. It should be noted that the relative arrangement of the components, the numerical expressions and numerical values set forth in these embodiments are not intended to limit the scope of the present invention unless it is specifically stated otherwise.

### First Exemplary Embodiment

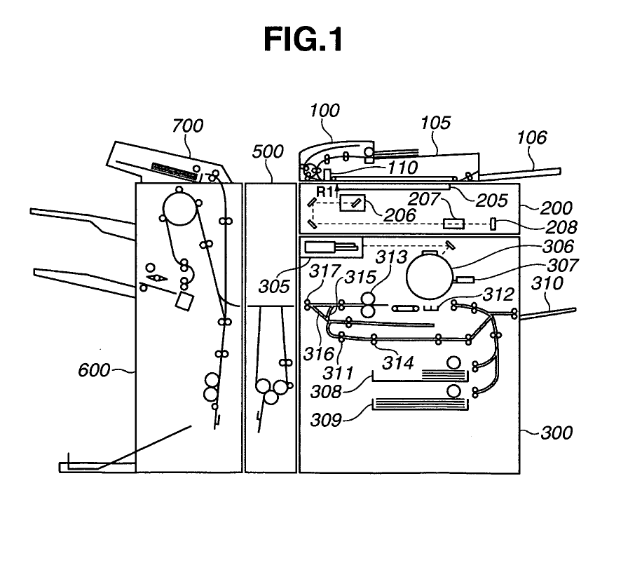

FIG. 1 is a schematic diagram showing an exemplary configuration of an image forming apparatus applied to an image reading apparatus according to a first embodiment of the present invention. The image forming apparatus includes an image forming apparatus main body including an image reader 200 and a printer unit 300, a folding device 500, and a finisher 600. A document feeding apparatus 100 is installed to an upper portion of the image reader 200.

The document feeding apparatus 100 feeds documents set onto a document tray 105 sheet by sheet from a first document, and then feeds the fed document onto a document glass stand 205 via a curved conveyance path. For a method of reading a one-sided document, first, the document is fed to and stopped at a reading position R1 on the document glass stand 205 so that a trailing edge of the document is positioned at the reading position R1, and a scanner unit 206 is moved from left to right as viewed in FIG. 1.

There are two modes for the document reading method, namely, a document fixed-reading mode in which the document is read by moving the scanner unit 206 and fixing the document on the glass stand 205, and a document feeding-reading mode in which the document is fed to the reading position R1 at a given reading speed and the document is read in a state where the scanner unit 206 is fixed at the reading position R1. After that, in either of the two modes, the read document is discharged onto a discharge tray 106.

For a method for reading a two-sided document, there is a method in which the front side of the document is read by the scanner unit 206 and the back side of the document is read by using an optical unit 110 disposed in the document feeding apparatus 100. A detailed explanation as to this method will be made later.

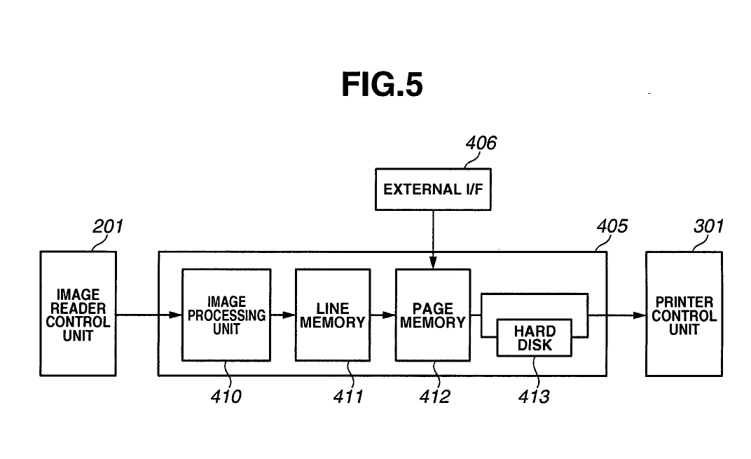

Within the optical unit 110, an image sensor, a light source, and the like (not shown) are disposed. An image of the document read by an image sensor 208, via a lens 207 is subjected to image processing before being stored in a hard disk 413 (see FIG. 5), and then sent to an exposure control unit 305 via a printer control unit 301 (see FIG. 5).

The exposure control unit 305 outputs a laser beam in accordance with an image signal. When the laser beam is irradiated onto a photosensitive drum 306, an electrostatic latent image is formed onto the photosensitive drum 306. The electrostatic latent image formed onto the photosensitive drum 306 is developed by a developing device 307. A developer on the photosensitive drum 306 is transferred by a transferring unit 312 onto a sheet fed from either of a sheet cassette 308, a sheet cassette 309, a manual sheet feeding unit 310, and a two-sided document conveyance path 311.

When the sheet onto which the developer is transferred is fed and guided to a fixing unit 313, the sheet is subjected to developer-fixing processing by the fixing unit 313. The sheet that has passed through the fixing unit 313 is then once guided from a conveyance path 315 to a conveyance path 314 by a flapper (not shown). Then, after the trailing edge of the sheet passes through the conveyance path 315, the sheet is switched back, and then is guided from a conveyance path 316 to a discharge roller 317. Thus, the sheet can be discharged by the discharge roller 317 from the printer unit 300 in a face-down state, in which a side of the sheet the developer is transferred onto is faced down. This is called a reverse discharge.

As described above, the sheet is discharged in the face-down state, and, therefore, image forming can be carried out in an appropriate order from a top page in printing the image obtained by reading a plurality of documents by using the document feeding apparatus 100.

Note that in a case where image forming is carried out onto a rigid sheet such as an OHP sheet from the manual sheet feeding unit 310, the sheet is not guided to the conveyance path 315, and is discharged from the discharge roller 317 in a face-up state, in which a side of the sheet onto which the developer is transferred is faced up.

In addition, in a case where image forming is carried out onto both sides of the sheet, the sheet is guided from the fixing unit 313 to the conveyance path 315 and the conveyance path 314. The sheet is then switched back immediately after the trailing edge of the sheet passes through the conveyance path 315, and after that, is guided to the two-sided document conveyance path 311 by a flapper (not shown). Then, an electrostatic latent image is again transferred by the transferring unit 312 onto the sheet that is guided to the two-sided document conveyance path 311. The sheet is then guided to the fixing unit 313, and is subjected to a fixing processing by the fixing unit 313.

A length of the paths, a disposition of the rollers, and a division of a drive system are determined and arranged so that the sheet can be fed even in a state where five half-size sheets such as an A4 sheet and a B5 sheet are fed in a series of paths extending from the transferring unit 312 via the two-sided document conveyance path 311 to return to the transferring unit 312.

Note that an order of discharge according to this processing is such that pages with an odd page number are discharged face-down, and accordingly, a page order in the case of two-sided copying can be appropriately arranged. The sheet discharged from the discharge roller 317 is sent to the folding device 500. The folding device 500 folds the sheet in a shape of “Z”.

If folding processing is specified to an A3-size sheet or a B4-size sheet, the sheet is sent to the finisher 600 after being subjected to the folding processing by the folding device 500. In the case of sheets other than the A3 sheet and the B4 sheet, the sheet is sent to the finisher 600 as it is, without being subjected to the folding processing by the folding device 500. The finisher 600 carries out processing such as bookbinding processing, stitching processing, and punching processing. In addition, an inserter 700 is provided in an upper portion of the finisher 600. The inserter 700 feeds a top cover, a slip sheet, and the like to the finisher 600.

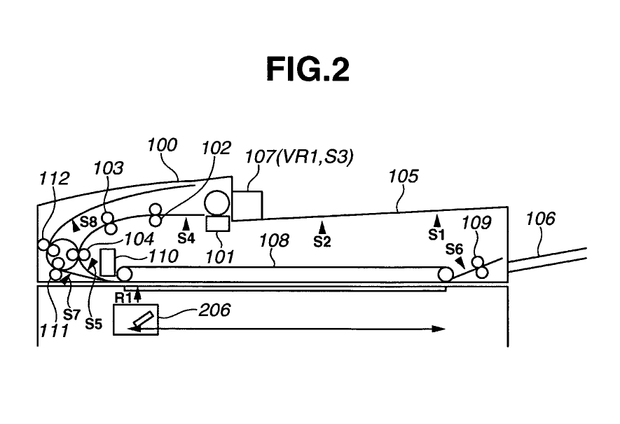

Hereinbelow, an explanation is made with reference to FIG. 2 as to document feeding in a one-sided document feeding-reading mode, in addition to an explanation of an exemplary configuration of the document feeding apparatus 100.

The document feeding apparatus 100 is provided with the document tray 105. The documents are stacked on a surface of the document tray 105. A document supply unit of the document feeding apparatus 100 draws a bundle of documents stacked onto the document tray 105 and a delivering roller (not shown) into a separation unit 101. The separation unit 101 separates a sheet placed at a top of the bundle of documents, and then feeds the separated document to conveyance rollers 102 and 103.

A registration roller 104 is in a stopped state when a leading edge of the document reaches the registration roller 104. The sheet is looped by conveyance by the conveyance rollers 102 and 103 to be skew-corrected, and after that, is fed to a document feeding unit to be described later. A document reading unit of the document feeding apparatus 100 feeds the document fed from the above-mentioned document supply unit to the reading position R1 at a predetermined conveyance speed, by using the registration roller 104 and a reading belt 108.

When the leading edge of the document reaches the reading position R1, an exposure operation is carried out by the scanner unit 206, which is fixed at the reading position R1. The reading operation is carried out with feeding the document. When the reading of the document ends, the document is fed to a document discharging unit by the reading belt 108. The document discharge unit discharges the document in a face-down state onto the discharge tray 106 by using a paper discharge roller 109.

Note that in the document feeding apparatus 100, even in a two-sided document reading mode, the scanner unit 206 can be used independently without using the optical unit 110 for back side reading, in accordance with a setting a user desires. In this case, the document feeding apparatus 100 is provided with a sheet surface reverse path so that the front and the back sides can be read by using the image sensor 208 (from FIG. 1) only. In addition, the document feeding apparatus 100 is provided with reversing rollers 111 and 112 attached to the image sensor 208. In this regard, the reading of the two-sided document performed by the document feeding apparatus having the sheet surface reverse path is a publicly known technology, and therefore, an explanation thereof is omitted in the explanation as to the present invention.

Note that in FIG. 2, various kinds of sensors S1 through S8 are disposed in the document feeding apparatus 100. In this regard, the document feeding apparatus 100 is provided with a large-size document detection sensor S1 and a small-size document detection sensor S2 that respectively detect a length of the document on the document tray 105, and a width detection potentiometer VR1 (not shown) and a width detection sensor S3 (not shown) that are disposed in a document width guide 107.

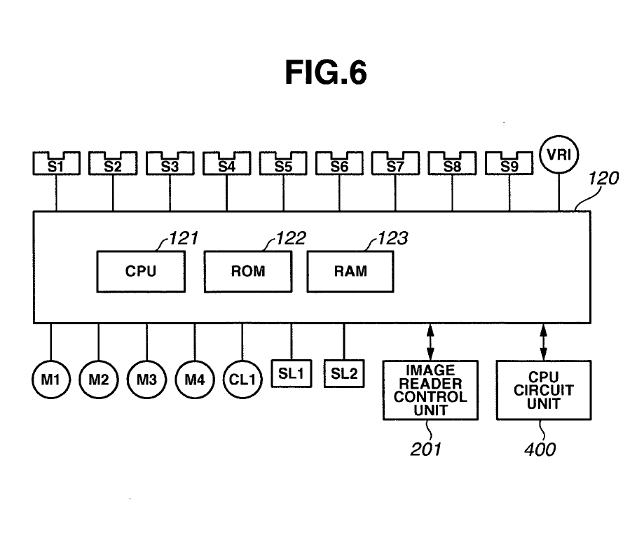

In addition, the document feeding apparatus 100 is also provided with a size sensor S4 that detects the document that is separated to be fed by detecting the leading and the trailing edges of the document while measuring a length of the document at the same time, a read sensor S5 that detects the leading edge of the document and transmits the read signal to the image reader 200, and a paper discharge sensor S6. Further, the document feeding apparatus 100 is provided with reversing sensors S7 and S8 that detect the document present in the sheet surface reverse path and a set-document detection sensor S9 that detects whether or not the document is set onto the document tray 105 (see FIG. 6).

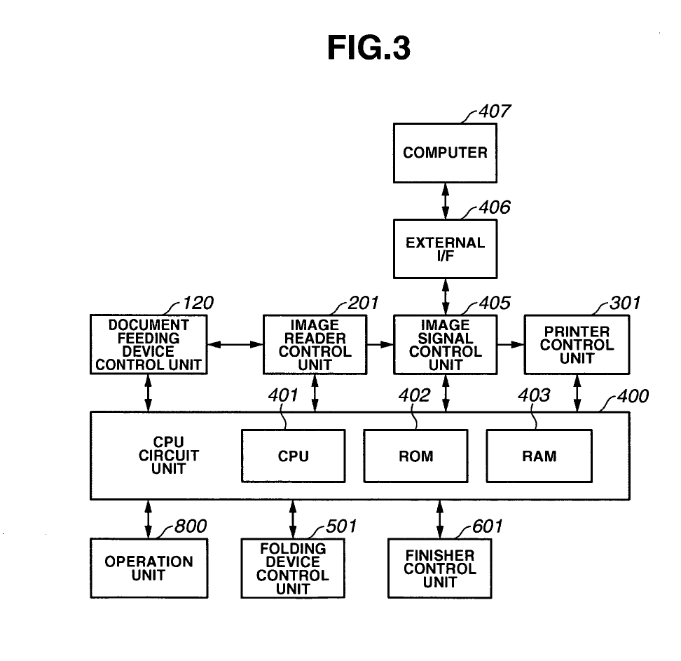

FIG. 3 is a block diagram showing a configuration of a control unit of the image forming apparatus. The control unit that controls over the image forming apparatus is constituted essentially by the CPU circuit unit 400. The CPU circuit unit 400 is provided with a CPU 401, a ROM 402, a RAM 403, and the like. A program that is executed by the CPU 401 is stored in the ROM 402. The RAM 403 is used as an area in which control data is temporarily stored and a work area for computation performed during a control operation.

The CPU circuit unit 400 controls a document feeding device control unit 120 that controls the document feeding apparatus 100, an image reader control unit 201 that controls the image reader 200, and an image signal control unit 405, in accordance with the settings performed through an operation unit 800. Further, the CPU circuit unit 400 controls the printer control unit 301 that controls the printer unit 300, a folding device control unit 501 that controls the folding device 500, a finisher control unit 601 that controls the finisher 600, and an external interface (I/F) 406.

The external I/F 406 is an interface with an external computer 407. The external I/F 406 rasterizes print data transmitted from the external computer 407 into image data and outputs the rasterized image data to the image signal control unit 405. Further, the external I/F 406 is capable of supporting a “SEND” function by which image data read by the image reader 200 is sent to the external computer 407 as an electronic data file. In addition, the external I/F 406 is also capable of supporting a pull scan function by which the settings for image reading are performed by means of the external computer 407 after the document is stacked onto the document tray 105.

The image reader control unit 201 performs image processing such as a shading correction with respect to the image read by the image sensor 208 and to the image read by an image sensor disposed in the optical unit 110. The read image data is output to the image signal control unit 405 and the image data outputted from the image signal control unit 405 to the printer control unit 301 is input to the exposure control unit 305.

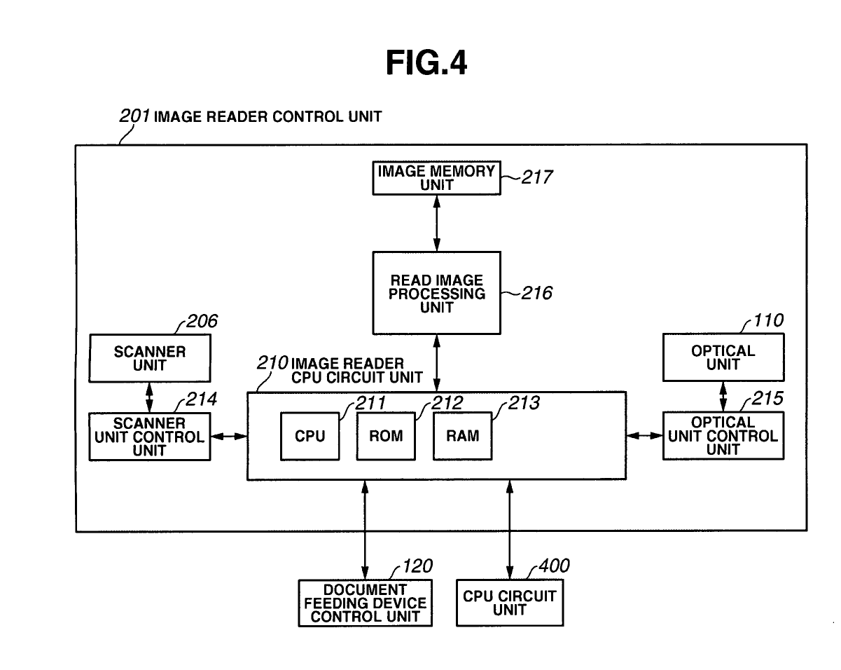

FIG. 4 is a block diagram showing an exemplary configuration of the image reader control unit 201. An image reader CPU circuit unit 210 that controls over the image reader 200 is provided with a CPU 211, a ROM 212, and a RAM 213. The ROM 212 stores a program. The RAM 213 is used as an area in which control data is temporarily stored and a work area for computation performed during a control operation.

The image reader CPU circuit unit 210 controls a scanner unit control unit 214 and a scanner unit 206. In addition, the image reader CPU circuit unit 210 reads image data of the front side of a document. Further, the image reader CPU circuit unit 210 controls an optical unit control unit 215 and the optical unit 110, and is capable of reading image data of the back side of a document.

The scanner unit control unit 214 also controls an optical motor (not shown) connected to the scanner unit 206. The read image data is sent to a read image processing unit 216. The read image processing unit 216 carries out processing such as a shading correction with respect to the sent image data. The read image processing unit 216 performs image processing on the read image for each of the front and the back sides of the read image in an appropriate order. An image memory unit 217 is a memory for writing and reading image information. The image memory unit 217 is provided with an interface for communication with the document feeding device control unit 120 and the CPU circuit unit 400 as well.

FIG. 5 is a block diagram showing an exemplary configuration of the image signal control unit 405. The image signal control unit 405 is provided with an image processing unit 410, a line memory 411, a page memory 412, and a hard disk 413. The image processing unit 410 carries out correction processing of an image and editing processing in accordance with the settings performed through the operation unit 800. The line memory 411 carries out mirror image processing, by which a direction of the image is changed in a main scanning direction. The image processed by the line memory 411 is outputted to the printer control unit 301 via the page memory 412. In addition, the hard disk 413 is used as necessary, for example, in changing an order of pages to be printed, as described later below. The hard disk 413 stores the image sent from the page memory 412.

FIG. 6 is a block diagram showing an exemplary hardware configuration of the document feeding device control unit 120. The document feeding device control unit 120 is provided with a CPU 121, a ROM 122, and a RAM 123. The ROM 122 stores a program. The RAM 123 is used as an area in which control data is temporarily stored and a work area for computation performed during a control operation. The document feeding device control unit 120 is provided with an interface for communication with the image reader control unit 201 of the image reader 200 and the CPU circuit unit 400.

The document feeding apparatus 100 is provided with a separation feeding motor M1 that separates a document and feeds the separated document by using the conveyance rollers 102 and 103, and is also provided with a registration motor M2 that drives the registration roller 104 and the reversing rollers 111 and 112. In addition, the document feeding apparatus 100 is provided with a feeding belt motor M3 that drives the reading belt 108, a paper discharge motor M4 that drives the paper discharge roller 109, clutch CL1, and solenoids SL1 and SL2.

Further, the document feeding apparatus 100 is provided with the width detection potentiometer VR1 and the above-mentioned various sensors S1 through S9. That is, the document feeding apparatus 100 is provided with the large-size document detection sensor S1, the small-size document detection sensor S2, the width detection sensor S3, the size sensor S4, the read sensor S5, and the paper discharge sensor S6. In addition, the document feeding apparatus 100 is also provided with the reversing sensors S7 and S8 and the set-document detection sensor S9. The sensors S1 through S9 are controlled by the CPU 121.

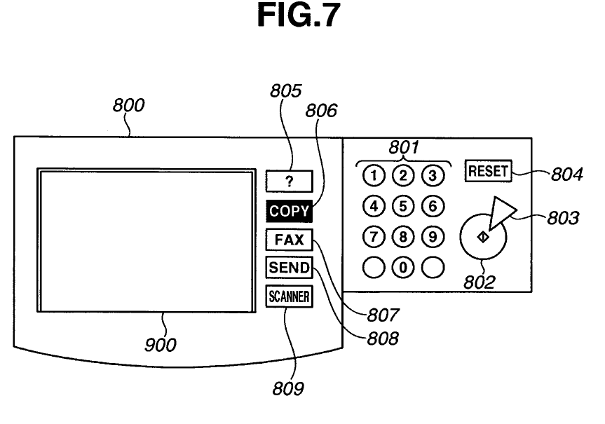

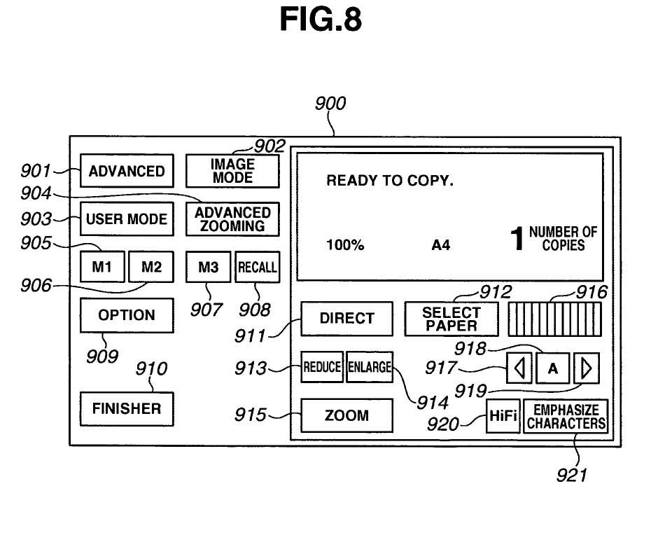

FIG. 7 is a schematic diagram showing an exemplary configuration of the operation unit 800 of the image forming apparatus. A touch panel sheet is attached to an LCD display unit 900 on an LCD portion. The LCD display unit 900 displays a screen for operating the system, and when a displayed key is pressed, transmits positional information of the pressed key to the CPU circuit unit 400. For the details of the screen to be displayed in this case, an explanation will be made later below with reference to FIG. 8.

Numeral keys 801 are used for inputting numerical values such as a number of copies to make. A “START” key 802 is used in starting a copying operation, the document reading operation, and the like after the user inputs desired conditions. A “STOP” key 803 is used in stopping an operation that is currently being carried out. A “RESET” key 804 is used for initializing the settings made by using the operation unit 800. In addition, reference numeral 805 denotes a guide key. When the user presses the guide key 805, an explanation of a key is displayed in the LCD portion.

Reference numeral 806 denotes a “COPY” mode key. The “COPY” mode key is used for starting a copying operation. Reference numeral 807 denotes a “FAX” key. The “FAX” key 807 is used for performing settings as to a facsimile function. Reference numeral 808 denotes a “SEND” key. The “SEND” key 808 is used for outputting file data to an external device such as a computer. Reference numeral 809 denotes a “SCANNER” key. The “SCANNER” key 809 is used for performing settings for reading an image from an external device such as a computer.

FIG. 8 shows an exemplary basic screen that is displayed in the LCD display unit 900 of the operation unit 800. Reference numeral 901 denotes an“ADVANCED” function key. When the user presses the “ADVANCED” key 901, the operation mode shifts to modes such as a two-sided copying mode, a multiple-composition copying mode, a moving mode, a mode for performing settings for a binding margin, a mode for performing settings for frame erasing, an mixed-document mode, which is related to the present invention, and the like.

Reference numeral 902 denotes an “IMAGE MODE” key. When the user presses the “IMAGE MODE” key 902, the operation mode shifts to a setting mode for performing processing to an image to be copied, such as half-tone dot meshing, shadowing, trimming, and masking. Reference numeral 903 denotes a “USER MODE” key. By using the “USER MODE” key 903, a registration of a mode memory and settings for a standard mode screen can be performed for each different user.

Reference numeral 904 is an “ADVANCED ZOOMING” key. When the “ADVANCED ZOOMING” key 904 is pressed, the operation mode shifts to a mode for enlarging or reducing with respect to an X direction and a Y direction of the document, independently from each other, and also to a mode of a zoom program in which a magnification ratio is computed on the bass of the size of the document and a size desired for the copying operation. Reference numerals 905, 906, and 907 denote an M1 key, M2 key, and M3 key, respectively, which can be pressed for recalling a mode memory corresponding to each of the M1, M2, and M3 keys.

Reference numeral 908 denotes a “RECALL” key. The “RECALL” key 908 is used for recalling the copying mode that is set for a previous operation. Reference numeral 909 denotes an “OPTION” key. The “OPTION” key 909 is used for performing settings as to an optional function such as a film projector for directly copying from a film and the like. Reference numeral 910 denotes a “FINISHER” key. The “FINISHER” key 910 is used for performing settings for a mode of the finisher 600 such as a sorting output mode and a group-outputting mode.

Reference numeral 911 denotes a “DIRECT” key. The “DIRECT” key 911 is used for setting a copying magnification ratio to “100%”. Reference numerals 913 and 914 respectively denote a “REDUCE” key and an “ENLARGE” key. The “REDUCE” key 913 and the “ENLARGE” key 914 are used for reducing and enlarging at a fixed ratio. Reference numeral 915 denotes a “ZOOM” key. The “ZOOM” key 915 is used for reducing and enlarging at an unfixed ratio in increments of 1%. Reference numeral 912 denotes a “SELECT PAPER” key. The “SELECT PAPER” key 912 is used for selecting a paper size of the document and a type of the paper used for copying.

Reference numerals 917 and 919 each denote a density key. When the density key 917 is pressed, the density is increased, and when the density key 919 is pressed, the density is decreased by a predetermined degree. Reference numeral 916 denotes a density indicator. When either of the density keys 917 and 919 is pressed, the density indicator 916 changes an indication to the currently applied density. Reference numeral 918 is an “AUTOMATIC EXPOSURE (AE)” key. The “AE” key 918 is used for performing copying by automatically adjusting the density when the document of high density on the base such as newspaper is used. Reference numeral 920 denotes a “HiFi” key. The “HiFi” key 920 is used for performing copying of a document mostly of the medium-tone density such as a photograph document. Reference numeral 921 denotes an “EMPHASIZE CHARACTERS” key. The “EMPHASIZE CHARACTERS” key 921 is used in a case where the user desires to emphasize characters in copying a text document.

Next, a detailed explanation is made as to a method for reading a two-sided document by using the optical unit 110 disposed in the document feeding apparatus 100 to which the present invention is applied. Note that with respect to an output format to be applied after an image is read according to the present invention, all of the “COPY” mode, “FAX” mode, “SEND” mode, “SCANNER” mode, and the like are included in the technical scope of the present invention. This is always applies in performing reading of a two-sided document by using the document feeding apparatus 100.

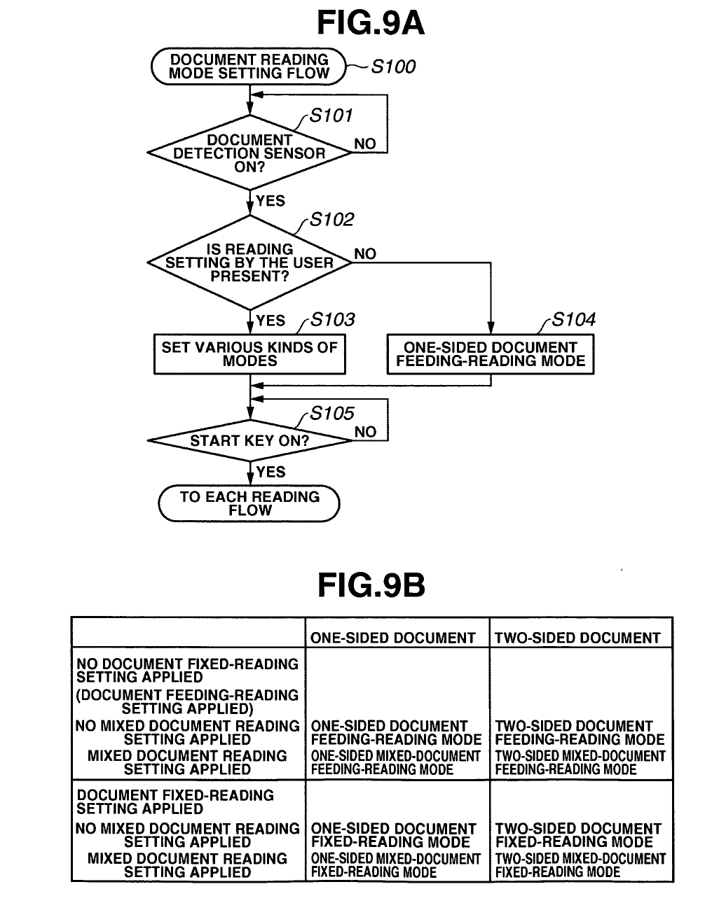

First, FIG. 9A is a flow chart showing a flow of a document reading mode setting in which a document is placed on the document tray 105 of the document feeding apparatus 100 and a user performs desired settings for reading the document. FIG. 9B is a diagram showing various types of operation modes of the document feeding apparatus 100.

In FIG. 9A, the process begins in the original reading mode setting flow (step S100). Next, the CPU 121 performs detection as to whether the user has placed the document onto the document tray 105 of the document feeding apparatus 100 or not, by using the set-document detection sensor S9 (step S101). When the document is set, it is determined whether the setting for reading the document is performed by the user using the operation unit 800 (step S102). In this case, it is assumed that in a normal status, the document is placed and set with the front side facing up and the back side facing down.

Items as to which the user performs the setting for reading the document include the following. Namely, the items of the setting performed by the user in this case include the setting as to the document size, whether the document is a one-sided document or a two-sided document, whether the document is a mixed document in which a plurality of different document sizes are simultaneously used in a mixture in a case where a plurality of documents are used, and whether the document is read in a document fixed-reading mode or in a document feeding-reading mode. The above-mentioned setting items are respectively performed by using the operation unit 800, and then, the CPU 121 determines the operation mode to be used among the various types of document reading operation modes, by a combination of the performed settings (step S103).

FIG. 9B shows a combination of the various types of reading operation modes that are set in step S103. For example, in a case where a two-sided document is used and no setting for mixed-document is applied, and no setting for the document fixed-reading mode is applied, then the operation mode is determined to be the two-sided document feeding-reading mode and the document is read in the two-sided document feeding-reading mode.

In addition, if the user does not especially perform the setting by using the operation unit 800 as to reading of a document, the CPU 121 determines that the reading of the document is performed in a one-sided document feeding-reading mode, which is a basic setting (step S104). After that, the processing waits for the user to press the “START” key 802 (step S105). When the “START” key 802 is pressed, reading of the document is started in a reading mode set by selecting from among the various types of reading modes.

In addition, in FIG. 9B, the modes applied for reading a two-sided document by using the optical unit 110 disposed in the document feeding apparatus 100 to which the present invention is applied are a two-sided document feeding-reading mode and a two-sided mixed-document feeding-reading mode. In the case where the reading mode is set to the one-sided document reading mode or to the document fixed-reading mode, image reading is carried out by using the scanner unit 206 only. In addition, even in the case of the mixed-document, if the documents of different width type (not shown) are used, the image reading is carried out in the document fixed-reading mode.

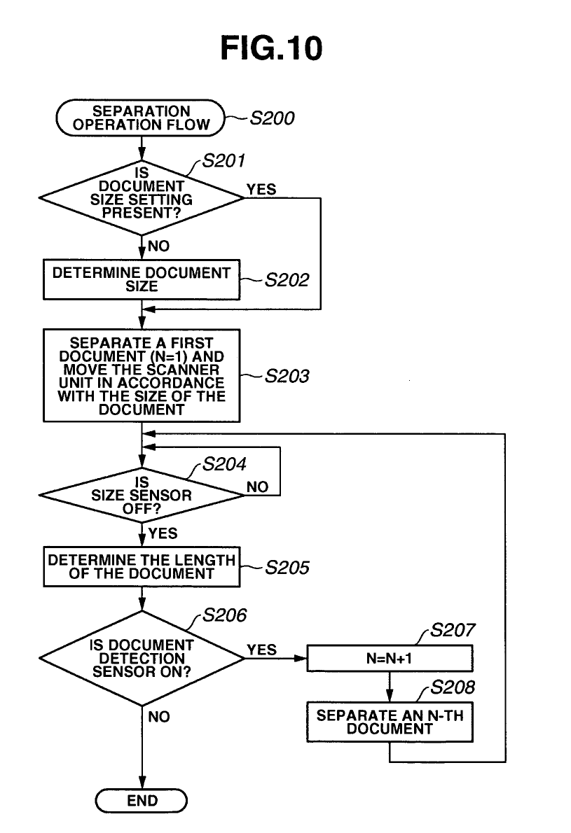

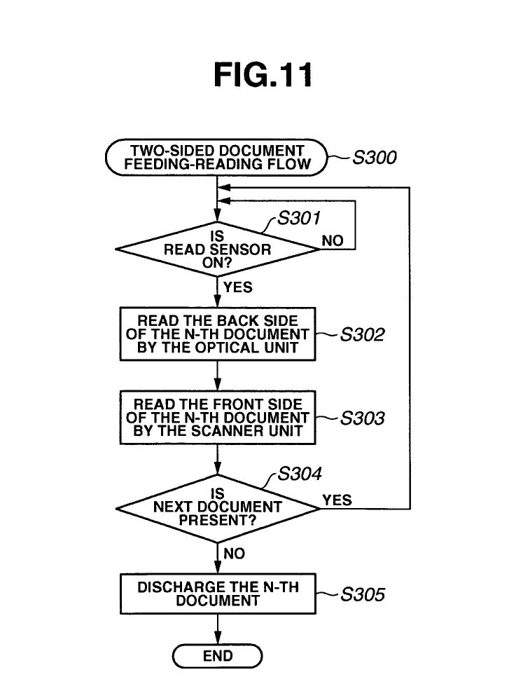

FIG. 10 is a flow chart showing an exemplary separation operation in a state after the two-sided document feeding-reading mode is set and the “START” key 802 is pressed, and FIG. 11 is a flow chart showing a reading operation performed in the two-sided document feeding-reading mode. In this embodiment, a detailed explanation is made as to a case where two A4-size two-sided documents are set onto the document tray 105 and the two-sided document feeding-reading mode is set, with reference to FIG. 10 and FIG. 11.

In a separation operation flow (step S200) as shown in FIG. 10, when the “START” key 802 is pressed, the CPU 121 determines whether the document size setting performed by the user is present or not (step S201). If it is determined that there is the document size setting performed by the user, the detection of the document size in step S202 to be described later is skipped. If there is no document size setting performed, the CPU 121 finally determines the document size in accordance with results of detection obtained by using the large-size document detection sensor S1, the small-size document detection sensor S2, the width detection potentiometer VR1, and the width detection sensor S3, which are disposed on the document tray 105 (step S202).

In this embodiment, the document size is determined to be A4-size. A first document (N=1) is drawn into the separation unit 101 by using a delivering roller (not shown). The first document is separated by the separation unit 101, and then fed to the conveyance rollers 102 and 103. At the same time, the scanner unit 206 is moved to a position distant from the optical unit 110 by a distance equivalent to the length of A4-size paper (namely, 210 mm) (step S203). This position is a reading position at which the front side of the A4-size document is read. In addition, if it is detected that the document is an A3-size document, the scanner unit 206 is moved to a position distant from the optical unit 110 by a distance equivalent to the length of A3-size paper (namely, 420 mm). This position is a reading position at which the front side of the A3-size document is read. Thus, the reading position of the front side of the document is controlled to be appropriately different in accordance with the difference of the sizes of the documents.

When a trailing edge of the first document passes through the size sensor S4 (step S204), the CPU 121 measures the length of the document, on the basis of a time period from the timing at which the size sensor is turned on to the timing at which the size sensor is turned off, and also on the basis of a motor clock of the separation feeding motor M1 (step S205). This is used in order to determine the length of the document in the case where the mixed-document reading mode is set.

Next, the CPU 121 determines whether the set-document sensor S9 is turned on or not (step S206). If it is determined that the set-document sensor S9 is turned on, the CPU 121 determines that the next document is stacked on the document tray 105. Then, the CPU 121 updates the value N to be (N+1) (step S207). Then, an N-th document (here, N=2) is separated (step S208). Then, the above-described operation is repeated.

If the set-document sensor S9 is determined to be off (step S206), the CPU 121 determines that the document is the last document, and the separation operation ends. Note that if there is the setting for the document paper size performed by the user in step S201, the detection as to the document size in step S202 is skipped. However, the document size detection may be performed for confirmation.

The technical scope of the present invention includes a configuration in which a warning is issued to the user if the set document size and the detected document size differ from each other. In a two-sided feeding-reading flow (step S300) shown in FIG. 11, the CPU 121 waits until a leading edge of a first document (N=1) reaches the read sensor S5 (step S301) after the leading edge of the first document is subjected to a skew correction by using the registration roller 104.

The reading of the back side of the first document performed by the optical unit 110 is started at a timing at which the leading edge of the first document reaches the optical unit 110 after the leading edge of the first document reaches the read sensor S5 (step S302). At the same time that the reading of the back side of the first document ends, the reading of the front side of the first document performed by the scanner unit 206 is started (step S303).

If there is a next document (step S304), the CPU 121 performs detection (step S301) as to whether the leading edge of a second document has reached the read sensor S5, in order to perform control so that the leading edge of the second document reaches the optical unit 110 at the same time that the reading of the front side of the first document ends. Then, the reading of the back side of the second document is performed, and then the above-described operation is repeated. If there is no next document (step S304), the document whose front side has been read is discharged (step S305). Then, the reading operation ends.

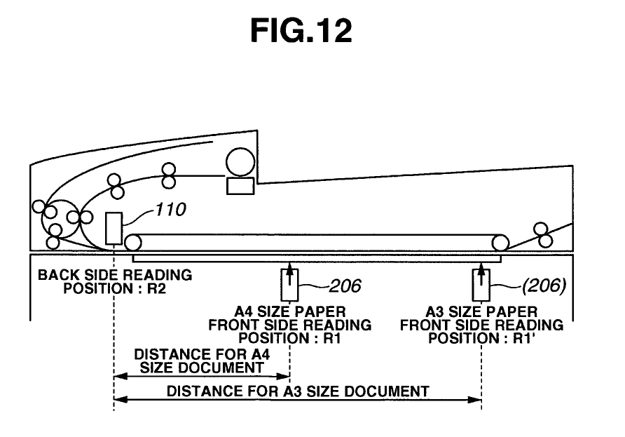

FIG. 12 is a schematic diagram showing reading positions in reading a two-sided document by using the optical unit 110 disposed in the document feeding apparatus 100 and the scanner unit 206. The reading of the back side is performed by the optical unit 110 at a reading position R2, regardless of the document size.

For the reading of the front side, in the case of an A4-size document, the position distant from the optical unit 110 by the length of A4-size paper (that is, by 210 mm) is a front side reading position R1 of the reading performed by the scanner unit 206. In the case of an A3-size document, the position distant from the optical unit 110 by the length of A3-size paper (namely, by 420 mm) is a front side reading position R1′ of the reading performed by the scanner unit 206.

Note that in this embodiment, the front side reading position is set to be at the position determined by the scanner unit 206 distant from the optical unit 110 by the distance equivalent to the length of the size of a document to be read. However, the distance between the optical unit 110 and the scanner unit 206 may be equivalent to or larger than the size of the document with respect to each of the reading position for the front side and the reading position for the back side. Therefore, even in the case of an A4-size document, the reading of the front side may be performed at the A3-size reading position R1′.

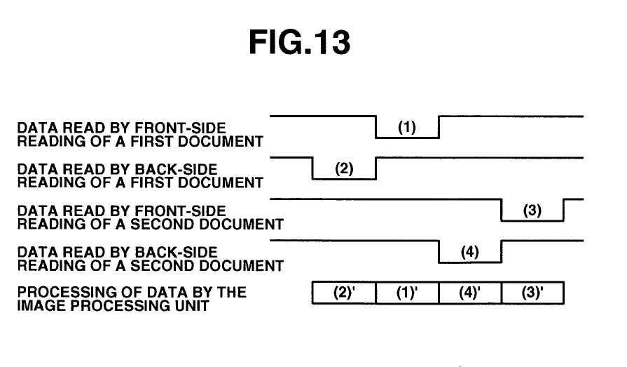

FIG. 13 is a diagram showing timing of processing of image data carried out by the image reader control unit 201 according to the present embodiment. In this case, first, reading (2) of the back side of a first document is performed by the optical unit 110, and the read image data is transferred to the read image processing unit 216. Next, the read image processing unit 216 performs image processing (2)′ for the back side of the first document.

Immediately after the reading (2) of the back side of the first document ends, the scanner unit 206 carries out reading (1) of the front side of the first document. Since the image processing (2)′ of the back side is already completed at this timing, the read image data of the front side of the first document is transferred as it is to the read image processing unit 216 without delaying transfer. Then, image processing (1)′ of the front side is carried out. With respect to reading of the back side of the second document, the second document is fed to the optical unit 110 at the timing at which the reading of the front side of the first document ends. Then, reading (4) of the back side of the second document is carried out by the optical unit 110, and the read image data is transferred to the read image processing unit 216. Next, the read image processing unit 216 performs image processing (4)′ for the back side of the second document. Immediately after the reading (4) of the back side of the second document ends, the scanner unit 206 carries out reading (3) of the front side of the second document. Since the image processing (4)′ of the back side is already completed at this timing, the read image data of the front side of the second document is transferred as it is to the read image processing unit 216 without delaying transfer. Then, image processing (3)′ of the front side is carried out. For a third and subsequent documents, the above-described operation is repeated to perform image processing in an appropriate order.

### Second Exemplary Embodiment

In the separation operation and the reading operation according to the first embodiment, an explanation has been made as to the case where the sizes of plural documents that are set onto the document tray 105 are the same. In the second embodiment of the present invention, an explanation is made as to a case where plural documents that are placed and stacked onto the document tray 105 are of mutually different sizes and are used in a mixture at the same time. Note that the second embodiment is different from the first embodiment only in processing carried out in the separation operation. However, the configuration of the second embodiment and other processings are the same as those of the first embodiment. Accordingly, a detailed explanation of the configuration and the same processings is not repeated herein.

Here, the separation operation performed after the “START” key 802 is pressed in the two-sided mixed-document feeding-reading mode is explained with reference to FIG. 10. In the second embodiment, a detailed explanation is made as to a case where one A4-size document and one A3-size document, namely, mixed two-sided documents of the same paper size type are simultaneously set onto the document tray 105 and where the two-sided mixed-document feeding-reading mode is set.

In the separation flow (step S200) shown in FIG. 10, when the “START” key 802 is pressed, the CPU 121 determines whether the document size setting performed by the user is present or not (step S201). In the two-sided mixed-document feeding-reading mode, plural documents of different sizes are always placed onto the document tray 105, and therefore, the user cannot perform setting as to the document paper size. Accordingly, the detection as to the document size is carried out just as in the case where there is no setting as to the document paper size.

In this case, the CPU 121 finally determines the document size in accordance with results of detection obtained by using the large-size document detection sensor S1, the small-size document detection sensor S2, the width detection potentiometer VR1, and the width detection sensor S3, which are disposed on the document tray 105 (step S202). In the case of mixed documents, a maximum size of the documents that are stacked on the document tray 105 in a mixture only can be detected. That is, in this embodiment, the document size of A3 is detected.

A first document (N=1) is drawn into the separation unit 101 by using a delivering roller (not shown), and the first document is separated by the separation unit 101. Then, the first document is fed to the conveyance rollers 102 and 103. At the same time, the scanner unit 206 is moved to a position distant from the optical unit 110 by a distance equivalent to the length of A3-size paper (namely, 420 mm) (step S203). This position is a reading position at which the front side of mixed documents is read. In the case of mixed documents, the reading position of the front side is determined in accordance with the size of a document that is the largest of the sizes of the stacked mixed documents.

When a trailing edge of the first document passes through the size sensor S4 (step S204), the CPU 121 measures the length of the document on the basis of a time period from the timing at which the size sensor S4 is turned on to the timing at which the size sensor S4 is turned off and also on the basis of a motor clock of the separation feeding motor M1. Thus, the size of the document is determined sheet by sheet as to each document. In this embodiment, the size of the first document is determined to be A4-size (step S205).

Next, the CPU 121 determines whether the set-document sensor S9 is turned on or not (step S206). If it is determined that the set-document sensor S9 is turned on, the CPU 121 determines that the next document is stacked on the document tray 105. Then, the CPU 121 updates the value N to be (N+1) (step S207). Then, an N-th document (here, N=2) is separated (step S208). Then, the above-described operation is repeated.

In this embodiment, the size of the second document is determined to be A3-size (step S205). If the set-document sensor S9 is determined to be off, the CPU 121 determines that the document is the last document. Thus, the separation operation ends. The reading operation according to this embodiment is the same as the flow shown in FIG. 11 described in the first embodiment.

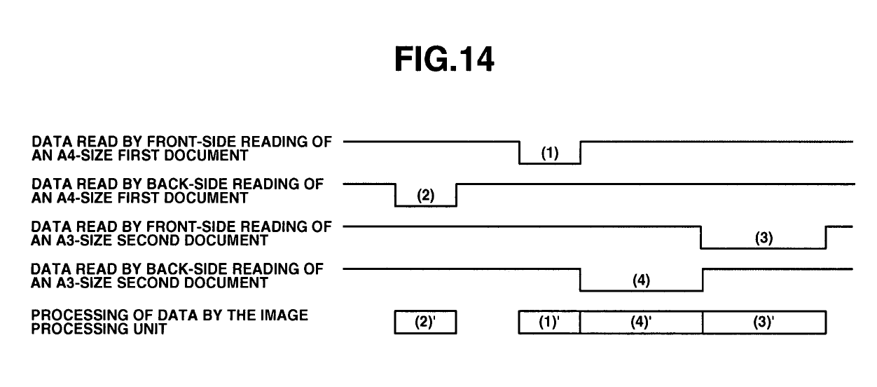

FIG. 14 is a diagram showing timing of processing of image data carried out by the image reader control unit 201 in a case where the two-sided mixed-document feeding-reading mode is executed. In this case, first, reading (2) of the back side of a first A4-size document is performed by the optical unit 110, and the read image data is transferred to the read image processing unit 216. Next, the read image processing unit 216 performs image processing (2)′ for the back side of the first document.

In the case of the two-sided mixed-document feeding-reading mode, the scanner unit 206 is moved to a reading position for the largest size document, that is, the scanner unit 206 is moved to the A3-size reading position in this embodiment. Therefore, reading of the front side of the first A4-size document is not carried out until the document is fed to the scanner unit 206. Reading (1) of the front side of the first document is carried out by the scanner unit 206, and the read image data of the front side of the first document is transferred to the read image processing unit 216. Then, image processing (1)′ of the front side is carried out.

With respect to reading of the back side of the second A3-size document, the second A3-size document is fed to the optical unit 110 at the timing at which the reading of the front side of the first document ends. Then, reading (4) of the back side of the second A3-size document is carried out. Next, the read image processing unit 216 performs image processing (4)′ for the back side of the second document. Immediately after the reading (4) of the back side of the second document ends, the scanner unit 206 carries out reading (3) of the front side of the second document. The read image data of the front side of the second document is transferred to the read image processing unit 216. Then, image processing (3)′ of the front side is carried out. Thus, the CPU 121 performs control so that image processing is carried out in an appropriate order.

### Third Exemplary Embodiment

With respect to the document feeding apparatus 100 shown in FIG. 2 described in the first embodiment and the second embodiment, the case where the optical unit 110 is disposed upstream of the scanner unit 206 is described as an example. However, the optical unit 110 may be disposed downstream of the scanner unit 206.

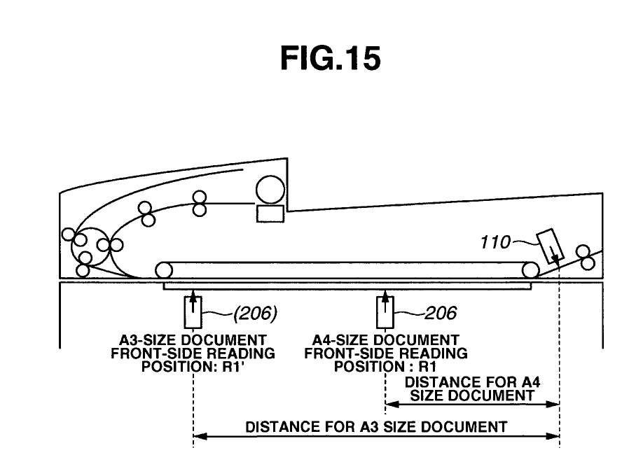

FIG. 15 is a schematic diagram showing reading positions in reading a two-sided document by the optical unit 110 and the scanner unit 206 in this case. In the first embodiment and the second embodiment, a reading operation is carried out in an order from the back side to the front side of a document. In the third embodiment, a reading operation is carried out in an order from the front side to the back side of a document. In this regard, however, other operations can be implemented in the same way as in the first embodiment and the second embodiment.

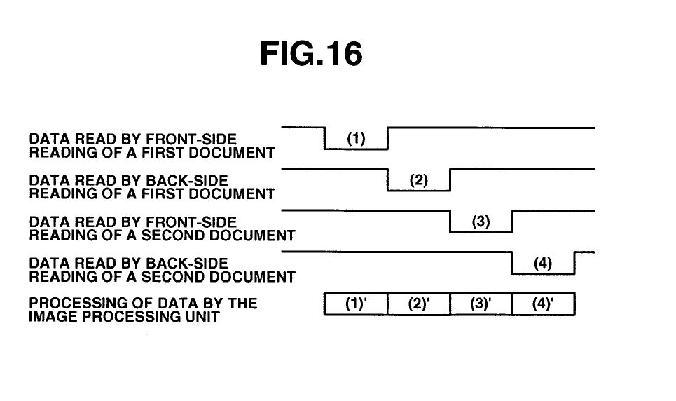

FIG. 16 is a diagram showing timing of processing of image data carried out by the image reader control unit 201 in a case where the third embodiment is implemented by using the document feeding apparatus having the configuration shown in FIG. 15. In this case, first, reading (1) of the front side of a first document is performed by the scanner unit 206, and the read image data is transferred to the read image processing unit 216.

Next, the read image processing unit 216 performs image processing (1)′ for the front side of the first document. Immediately after the reading (1) of the front side of the first document ends, the optical unit 110 carries out reading (2) of the back side of the first document. Because the image processing (1)′ of the front side is already completed at this timing, the read image data of the back side of the first document is transferred as it is to the read image processing unit 216 without delaying transfer. Then, image processing (2)′ of the back side is carried out. With respect to reading of the front side of the second document, the second document is fed to the scanner unit 206 at the timing at which the reading of the back side of the first document ends. Then, reading (3) of the back side of the second document is carried out by the scanner unit 206, and the read image data is transferred to the read image processing unit 216. Next, the read image processing unit 216 performs image processing (3)′ for the front side of the second document. Immediately after the reading (3) of the front side of the second document ends, the optical unit 110 carries out reading (4) of the back side of the second document. Since the image processing (3)′ of the back side is already completed at this timing, the read image data of the back side of the second document is transferred as it is to the read image processing unit 216 without delaying transfer. Then, image processing (4)′ of the back side is carried out.

For a third document and subsequent documents, the above-described operation is repeated to perform image processing in an appropriate order. In the two-sided mixed-document feeding-reading mode also, the reading operation is carried out in an order from the front side to the back side of a document. In this regard, however, other operations can be implemented in the same way.

In addition, in the above-mentioned first embodiment and second embodiment, the front side reading position is set to be at the position determined by the distance between the optical unit 110 and the scanner unit 206 equivalent to the length of the size of a document to be read. However, the same effect can be obtained by previously fixing the scanner unit 206 at the position distant from the back side reading position by the distance equivalent to the length of the document size. In this case, a moving operation is not carried out after the start of reading is instructed. Therefore, a throughput at the start of the reading operation can be improved.

### Fourth Exemplary Embodiment

In the above-mentioned first embodiment, second embodiment, and third embodiment, the case where the user can perform setting as to the document size by using the operation unit 800 is described as an example. In this regard, in a pull scan function in which the setting for image reading is performed from the external computer 407, the setting for the document size may be performed by the user using the external computer 407.

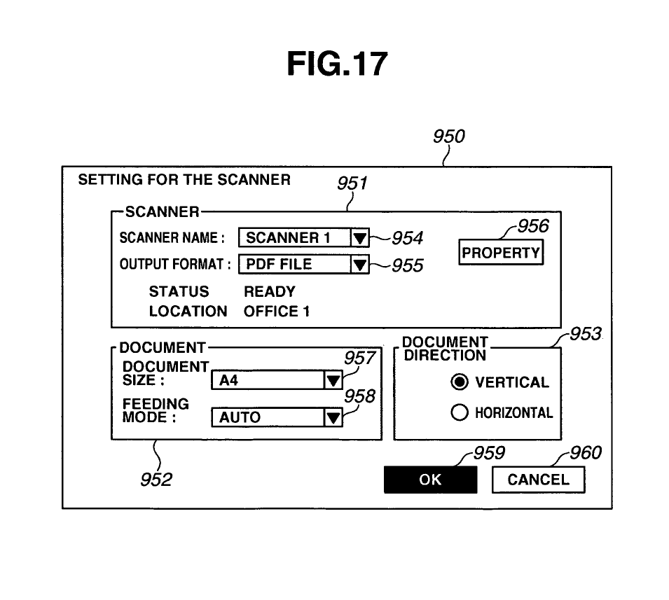

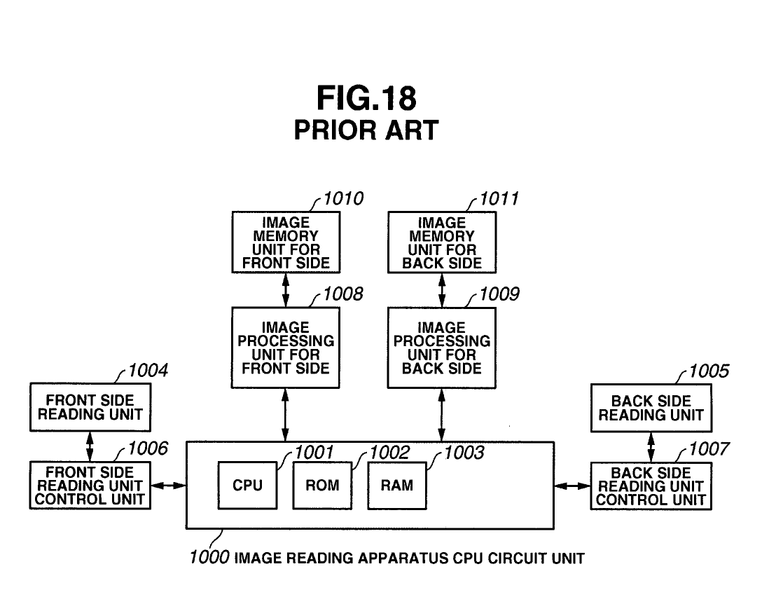

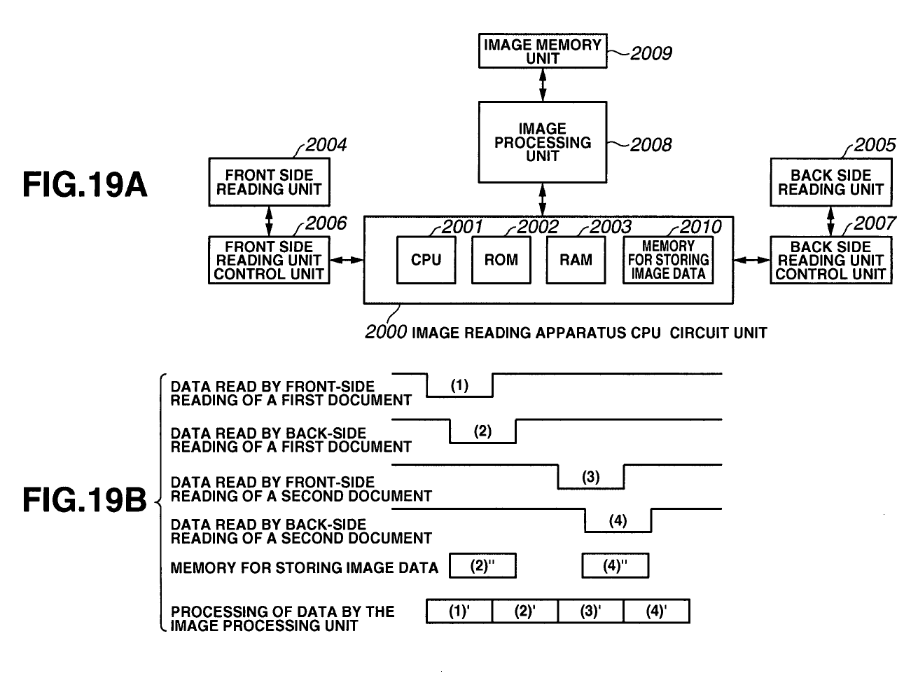

FIG. 17 is a schematic diagram showing an exemplary reading setting screen 950 for the pull scan function as displayed by a display (not shown) of the external computer 407. In a scanner setting frame 951, a scanner selection key 954 by which a desired scanner can be selected from among plural scanners connected to the external computer 407 and an output format selection key 955 for selecting a file format after image reading is carried out are displayed.

Further, in the scanner setting frame 951, a state of the selected scanner and a location at which the scanner is installed are displayed. A “PROPERTY” key 956 is a key for setting image quality and the like to perform a more detailed setting for the reading operation. A document setting frame 952 is a frame for allowing the user to perform setting with respect to a document placed onto the document tray 105 of the document feeding apparatus 100 or the document glass stand 205. A document size selection key 957 is a key for setting the size of the placed document. By using the document size selection key 957, various sizes such as “A3”, “A4”, and the like can be selected. The default setting of the document size selection key 957 is set to be “AUTO”. If the setting “AUTO” is selected, the document size is detected by the document feeding apparatus 100 or by the image reader 200.

A “FEEDING MODE” key 958 is a key for selecting the feeding mode for a document. By using the “FEEDING MODE” key 958, the user can perform a selection as to whether the document feeding apparatus 100 is used for feeding documents or whether documents are manually placed by the user onto the document glass stand 205 sheet by sheet. An “DOCUMENT DIRECTION” frame 953 is a frame for allowing the user to set a direction of feeding documents. When the setting for the pull scan function is completely performed by the user, reading of a document is started by pressing an “OK” key 959. A “CANCEL” key 960 is used for canceling the set settings.

Other operations carried out after the “OK” key 959 is pressed to start the reading of a document can be implemented in the same way as the first embodiment, the second embodiment, and the third embodiment. Accordingly, a detailed explanation thereof is not repeated.

### Other Exemplary Embodiments

As described above, exemplary embodiments of the present invention are explained in detail. However, the present invention may be applied to a system constituted by plural devices and to an apparatus constituted by a single device.

Note that the present invention can be achieved by supplying a program that implements the functions of the above embodiments to a system or to an apparatus, directly or from a remote location, and by causing the system or the apparatus to read and execute code of the supplied program. In this case, the program code itself, which is installed to a computer in order to implement the functions and the processing of the present invention by the computer, is included within the technical scope of the present invention.

In this case, the program code may take a form such as an object code, a program executed by an interpreter, script data supplied to an operating system (OS), and the like, regardless of a form of the program, as long as the program code has a function as a program.

For a recording medium for supplying the program, for example, a floppy (registered trademark) disk, a hard disk, an optical disk, a magneto-optical disk, a CD-ROM, a CD-R, a CD-RW, and the like can be used. In addition, as a recording medium, there are a magnetic tape, a nonvolatile memory card, a ROM, a DVD (DVD-ROM and DVD-R), and the like.

In addition, for a method for supplying the program, a method may be employed by which the program is supplied by being downloaded from a web site on the Internet using a browser of a client computer. Further, the program may be supplied by downloading a computer program according to the present invention itself or a compressed file that includes an automatic installation function to a recording medium such as a hard disk.

The functions of the above embodiments can also be implemented by dividing the program code into a plurality of files and downloading each divided file from different web pages. That is, a WWW server for having a plurality of users download the program file for implementing a function processing of the present invention configures the present invention.

In addition, the program according to the present invention may be distributed to users by encrypting the program and storing the program on a storage medium such as a CD-ROM. In this case, the program may be installed to the computer by a method in which key information for decrypting the encrypted program is downloaded from a web page on the Internet only by a user who satisfies a predetermined condition and the encrypted program is decrypted by using the downloaded key information.

In addition, the functions according to the embodiments described above are implemented not only by executing the program code read by the computer, but also implemented by the processing in which an operating system (OS) or the like carries out a part of or the whole of the actual processing on the basis of the instruction given by the program code.

Further, in another aspect of the embodiment of the present invention, after the program code read from the storage medium is written in a function enhancing board inserted in the computer or a memory which is provided in a function enhancing unit connected to the computer, the CPU and the like provided in the function enhancing board or the function enhancing unit carries out a part of or the whole of the processing to implement the functions of the embodiments as described above. The above-described functions of the present invention can be implemented by such processing.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2005-188299 filed Jun. 28, 2005 and No. 2005-366452 filed Dec. 20, 2005, which are hereby incorporated by reference herein in their entirety.

What is claimed is:

1. An image reading apparatus including an automatic document feeding unit adapted to feed a document that is stacked onto a document holding unit to a reading position and being capable of reading both images of a front side and a back side of the document, the image reading apparatus comprising:
a size information obtaining unit adapted to obtain size information of the document;
a first reading unit adapted to read an image of one side of the document;
a second reading unit adapted to read an image of another side of the document; and
a moving unit adapted to move the second reading unit,
wherein the first reading unit reads the image of one side of the document at a first reading position,
wherein the moving unit moves the second reading unit to a second reading position that is different from the first reading position, in accordance with the size information of the document obtained by the size information obtaining unit, and
wherein the second reading unit reads the image of another side of the document at the second reading position.

2. The image reading apparatus according to claim 1, wherein the size information obtaining unit includes a detection unit adapted to detect a size of a document stacked on the document holding unit.

3. The image reading apparatus according to claim 1, wherein the size information obtaining unit includes a document size setting unit that allows a user to perform setting with respect to a size of a document.

4. The image reading apparatus according to claim 3, wherein the image reading apparatus is connected to an external device, and
wherein the external device includes the document size setting unit.

5. The image reading apparatus according to claim 1, wherein the second reading position is a position distant from the first reading position by a distance that is about equivalent to or larger than a length of the size of the document.

6. The image reading apparatus according to claim 1, wherein if a plurality of documents are stacked onto the document holding unit and the plurality of stacked documents are mixed documents that include a plurality of different sizes, a document size that is the largest of the plurality of different sizes is set as the size information.

7. The image reading apparatus according to claim 1, further comprising:
an image processing unit adapted to perform processing of image data of the image read by either the first reading unit or the second reading unit; and
a control unit adapted to transfer the image data from either the first reading unit or the second reading unit to the image processing unit,
wherein the control unit, after completion of transferring the image data of the image read by the first reading unit to the image processing unit, starts to transfer the image data of the image read by the second reading unit to the image processing unit without delaying transfer by a time period about equivalent to at most one page of the document.

8. An image reading method for an image reading apparatus including an automatic document feeding unit adapted to feed a document that is stacked onto a document holding unit to a reading position and being capable of reading both images of a front side and a back side of the document, the image reading method comprising:
a size information obtaining step of obtaining size information of the document;
a first reading step of reading an image of one side of the document by a first reading unit;
a second reading step of reading an image of another side of the document by a second reading unit; and
a movement controlling step of moving the second reading unit,
wherein in the first reading step, the first reading unit reads the image of one side of the document at a first reading position,
wherein in the movement controlling step, the second reading unit is moved to a second reading position that is different from the first reading position, in accordance with the size information of the document obtained in the size information obtaining step; and
wherein in the second reading step, the second reading unit reads the image of another side of the document at the second reading position.

9. The image reading method according to claim 8, wherein the size information obtaining step includes a document size detection step.

10. The image reading method according to claim 8, wherein the size information obtaining step includes a document size setting step.

11. The image reading method according to claim 8, wherein the second reading position is a position distant from the first reading position by a distance that is about equivalent to or larger than a length of the size of the document.

12. The image reading method according to claim 8, wherein if a plurality of documents are stacked onto the document holding unit and the plurality of stacked documents are mixed documents that include a plurality of different sizes, a document size that is the largest of the plurality of different sizes is set as the size information.

13. The image reading method according to claim 8, further comprising:
an image processing step of allowing an image processing unit to perform processing of image data of the image read in either the first reading step or the second reading step; and
a control step of transferring the image data from either the first reading unit or the second reading unit to the image processing unit,
wherein the control step includes a step of, after completion of transferring the image data of the image read in the first reading step to the image processing unit, starting to transfer the image data of the image read in the second reading step to the image processing unit without delaying transfer by a time period about equivalent to at most one page of the document.

14. A program executable by a computer for controlling an image reading apparatus including an automatic document feeding unit adapted to feed a document that is stacked onto a document holding unit to a reading position and being capable of reading both images of a front side and a back side of the document, the program comprising:
a size information obtaining module for obtaining size information of the document;
a first reading module for reading an image of one side of the document by a first reading unit;
a second reading module for reading an image of another side of the document by a second reading unit; and
a movement control module for moving the second reading unit,
wherein in the first reading module, the first reading unit reads the image of one side of the document at a first reading position,
wherein in the movement control module, the second reading unit is moved to a second reading position that is different from the first reading position, in accordance with the size information of the document obtained in the size information obtaining module, and
wherein in the second reading module, the second reading unit reads the image of another side of the document at the second reading position.

15. The program according to claim 14, wherein the size information obtaining module includes a document size detection module.

16. The program according to claim 14, wherein the size information obtaining module includes a document size setting module.

17. The program according to claim 14, wherein the second reading position is a position distant from the first reading position by at least a distance that is equivalent to or larger than a length of the size of the document.

18. The program according to claim 14, wherein if a plurality of documents are stacked onto the document holding unit and the plurality of stacked documents are mixed documents that include a plurality of different sizes, a document size that is the largest of the plurality of different sizes is used as the size information.

19. The program according to claim 14, further comprising:
an image processing module for allowing an image processing unit to perform processing of image data of the image read in either the first reading module or the second reading module; and
a control module for transferring the image data from either the first reading unit or the second reading unit to the image processing unit,
wherein the control module includes a module for, after completion of transferring the image data of the image read in the first reading module to the image processing unit, starting to transfer the image data of the image read in the second reading module to the image processing unit without delaying transfer by a time period about equivalent to at most one page of the document.
